(19) United States
(12) Patent Application Publication
(10) Pub. No.: US 2013/0126061 A1
(43) Pub. Date: May 23, 2013

(54) Tire for Two-Wheeled Vehicles, Comprising a Tread Having Sipes

(71) Applicant: Luc Bestgen, Chatel-Guyon (FR)

(72) Inventor: Luc Bestgen, Chatel-Guyon (FR)

(21) Appl. No.: 13/578,809

(22) PCT Filed: Feb. 4, 2011
(86) PCT No.: PCT/EP2011/051634

§ 371 Date: Oct. 23, 2012

(30) Foreign Application Priority Data
Feb. 12, 2010 (FR) 1050990

(51) Int. Cl. B60C 11/12

(52) U.S. Cl. CPC B60C 11/12
USPC 152/209.18

(57) ABSTRACT

A tire for a motorized two-wheeled vehicle comprising a reinforcing structure of the carcass type, anchored on each side of the tire to a bead, each bead being extended radially outwards by a sidewall, the sidewalls radially towards the outside joining to a tread. At least the surface of the tread includes a first polymer compound extending over at least part of the central part and of at least one second polymer compound having physico-chemical properties different from those of the first polymer compound and covering at least part of the axially external parts of the tread, at least the central part of the tread comprises at least one incision, in the central part of the tread consisting of includes the first polymer compound, in a circumferential plane, at least part of one wall of the at least one incision is formed of at least two straight lines, each of the straight lines making with the radial direction an angle of between 5 and 65° and the directions of the straight lines making an angle of between 30 and 120° between them.

The invention relates to a tire intended to be fitted to a vehicle and more particularly intended to be fitted to a two-wheeled vehicle such as a motorbike and, more specifically still, to a tire intended to be fitted to a motorbike with a speed rating higher than W which corresponds to a speed of 270 km/h.

Although not limited to such an application, the invention will be described more particularly with reference to such a motorcycle or motorbike tire, and more specifically still, with reference to a tire intended to be fitted to the rear wheel.

As with all other tires, motorbike tires too are going radial, the architecture of such tires comprising a carcass reinforcement made up of one or two layers of reinforcing elements which with the circumferential direction make an angle that may be between 65 and 90°, the said carcass reinforcement being radially surmounted by a crown reinforcement made up of reinforcing elements. However, some non-radial tires do still remain and the invention relates to these also. The invention further relates to tires which are partially radial, which means tires in which the reinforcing elements of the carcass reinforcement are radial over at least part of the said carcass reinforcement, for example in the part corresponding to the crown of the tire.

Numerous crown reinforcement architectures have been proposed, depending on whether the tire is intended to be fitted at the front of the motorbike or fitted at the rear. A first structure, for the said crown reinforcement, involves using only circumferential cords, and the said structure is more particularly used for rear tires. A second structure, inspired directly by the structures commonly used on passenger vehicle tires, has been used to improve resistance to wear, and involves using at least two working crown layers of reinforcing elements that are substantially parallel to one another within each layer but crossed from one layer to the next, making acute angles with the circumferential direction, such tires being more particularly suitable as front tires for motorbikes. The said two working crown layers may be combined with at least one layer of circumferential elements, generally obtained by helical winding of a strip of at least one rubber-coated reinforcing element.

The choice of tire crown architecture has a direct impact on certain properties of the tires, such as wear, endurance, grip or even drivability or, particularly in the case of motorbikes, stability. However, other tire parameters such as the nature of the rubber compounds of which the tread is made also have an impact on the properties of the said tire. The choice and nature of the rubber compounds of which the tread is made are, for example, essential parameters as far as wear properties are concerned. The choice and nature of the rubber compounds of which the tread is made also have an impact on the grip of the tire.

It is also known practice for other types of tire to produce treads comprising incisions, more particularly for tires intended to run on ground covered with snow, black ice, or wetness.

Such treads are usually provided with raised elements of the rib or block type, separated from one another in the circumferential direction and/or in the transverse direction by transverse and/or circumferential grooves. These treads then also comprise incisions or slits, the non-zero widths of which are very much smaller than those of the aforementioned grooves. By making a plurality of cuts that open onto the tread surface a plurality of rubber edges is created and these cut into the layer of water that may be present on the road surface in order to keep the tire in contact with the ground and create cavities that may potentially form ducts intended to collect the water present in the contact patch via which the tire makes contact with the road and remove if it they are configured in such a way as to open out outside the contact patch.

Numerous types of incision have already been proposed with a view to improving the grip of the tire on the surfaces in question.

Document FR 2 418 719 for example describes incisions which may be normal to the surface of the tread or inclined with respect to the direction perpendicular to the said surface.

Document FR 791 250 describes incisions that follow a wavy line on the surface of the tread.

Motorbike performance, notably in terms of grip on wet road surfaces have led to the offering of tires with treads comprising incisions in order to contribute towards improving the transfer of driving or braking torque and thus improve the ability of motorbikes to accelerate or brake.

Tests conducted on tires comprising incisions cut into the tread such that in a circumferential plane the walls of the incisions that are oriented radially have revealed, notably on the central part of the tires, that these tires show irregular patterns of wear. Such patterns of wear become more pronounced with increased wear and lead to a greater rate of wear of the tire.

The inventors therefore set themselves the mission of providing a motorbike tire of which the grip, notably on wet ground, is similar to that of the aforementioned tires that comprise incisions but with less degradation of properties in terms of wear as compared with tires that do not have incisions and, more particularly, without increasing their rate of wear.

It is therefore an object of the invention to provide a motorbike tire of which the properties in terms of grip are improved notably on wet ground, while retaining a rate of wear that is satisfactory.

This object has been achieved according to the invention by a tire for a motorized two-wheeled vehicle comprising a reinforcing structure of the carcass type, made up of reinforcing elements, anchored on each side of the tire to a bead the base of which is intended to be mounted on a rim seat, each bead being extended radially outwards by a sidewall, the sidewalls radially towards the outside joining to a tread, at least the surface of the tread consisting of a first polymer compound extending over at least part of the central part and of at least one second polymer compound having physico-chemical properties different from those of the said first polymer compound and covering at least part of the axially external parts of the tread, at least the central part of the tread comprising at least one incision, in the central part of the tread consisting of the said first polymer compound, in a circumferential plane, at least part of one wall of the said at least one incision being formed of at least two lines, each of the lines making with the radial direction an angle of between 5 and 65°, and the directions of two successive lines making an angle of between 30 and 120° between them.

According to the invention, the tire therefore, in its central part, comprises incisions which, in cross section in a circumferential plane, have at least the shape of a V, or chevron lying down, one the ends of which lies flush with the surface of the tread, the branches of the V consisting of two successive lines of the said at least two lines.

Within the meaning of the invention, an incision is a cut that forms two walls and in which the distance between the walls measured along the normal to a plane tangential to one of the walls is less than 1.5 mm and preferably less than 1 mm. The said distance on the surface of the tread is at least equal to the said distance at the bottom of the incision, which means to say at the point furthest from the surface of the tread. Particularly in the case of a motorbike tire, as the thickness of the tread is relatively small, any widening of the said distance from the surface of the tread towards the bottom of the incision cannot be allowed to exist in case it causes the edges of the incision to collapse at the surface of the tread thus reducing the area of the contact patch in which the tread makes contact with the ground.

The longitudinal direction of the tire, or circumferential direction, is the direction corresponding to the periphery of the tire and defined by the direction of running of the tire.

The transverse or axial direction of the tire is parallel to the axis of rotation of the tire.

The axis of rotation of the tire is the axis about which it rotates in normal use.

A circumferential plane or a circumferential plane of section is a plane perpendicular to the axis of rotation of the tire. The equatorial plane is the circumferential plane that passes through the center or crown of the tread.

A radial or meridian plane contains the axis of rotation of the tire.

The radial direction is a direction intersecting the axis of rotation of the tire and perpendicular thereto. The radial direction is the intersection between a circumferential plane and a radial plane.

A tire thus produced according to the invention and mounted on the rear wheel of a motorbike effectively, notably on wet or damp ground, affords grip performance which is an improvement over tires that have no incisions. Furthermore, during running, uneven wear is very much reduced by comparison with the wear observed, when running under the same conditions, with tires that have incisions cut into the tread such that in a circumferential plane the walls of the incisions are oriented radially. When tire tread wear increases, it would seem that the unevenness becomes even less.

The inventors have noticed that, in a circumferential plane, the V-shape of the incisions, which are made of at least two parts that are the two lines, over the course of tire wear constitutes two successive parts, each one being inclined with respect to the radial direction in a circumferential plane of section. The inventors believe that they have demonstrated that the orientation of each of the parts of the incision in a circumferential plane with respect to the radial direction leads to uneven wear that is less pronounced than that of an incision cut into the tread such that in a circumferential plane its walls are oriented radially. The inventors also notice that the opposite successive orientations of the two parts of the incision lead to unevennesses that compensate for one another to result in a pattern of wear with unevennesses that are not very pronounced when the tire wear corresponds to a second part of the incision.

According to one advantageous embodiment of the invention, the said two successive lines are connected by an arc of a circle. In other words, the V-shape made up of two successive lines does not have a sharp point but a rounded connected between the two lines or branches of the V. Such a shape makes it easier to design the part of the mold that will penetrate the tread to form the incision.

One preferred embodiment of the invention, with one wall of the said at least one incision being formed of two lines, has it that the intersection of the directions of the said two lines is oriented in the running direction of the tire with respect to the ends of the said two lines. In other words, the point of the V, or more specifically the arc of a circle, which connects the said two lines according to the aforementioned advantageous embodiment, is oriented with respect to the said two lines in the running direction of the tire.

The inventors have also been able to demonstrate that producing the incision in this way contributes to reducing the rate of wear of the tire. Specifically, tests carried out have shown that identical incisions oriented in the opposite direction, namely with the point of the V or, more specifically, the arc of a circle which connects the said two lines according to the aforementioned advantageous embodiment, oriented with respect to the said two lines in the opposite direction to the running direction of the tire lead to a higher rate of wear.

The presence of these incisions only in the central part of the tire makes it possible to reduce the rate of wear in the region of the tire where torque transfer is the greatest both under acceleration and under braking without excessively impacting on the manufacturing costs, V-shaped incisions naturally being more expensive to produce. The tire may, on the other hand, have other types of incision on the axially external parts in order to improve grip performance under cornering.

Combining V-shaped incisions with a tread made of several polymer compounds distributed between the central part and the axially external parts allows the creation of a tread which, for example, has improved wear-related properties in the center of the tread and improved grip-related properties on the axially external parts.

It is thus possible to make the central part of the tread that has improved wear-related properties coincide with the V-shaped incisions. Such an embodiment further contributes towards limiting the rate of wear in the central part of the tire.

According to one preferred embodiment of the invention, the second polymer compound has a Shore A hardness different from that of the first polymer compound.

Advantageously according to the invention, the Shore A hardness of the said first polymer compound that makes up at least part of the central part and of the said at least one second polymer compound that makes up at least part of the axially external parts differ by at least one unit and preferably two.

Advantageously also, the Shore A hardness of the said first polymer compound that makes up at least part of the central part is higher than that of the said at least one second polymer compound that makes up at least part of the axially external parts.

The Shore A hardness of the polymer compounds after curing is assessed in accordance with the ASTM D 2240-86 standard.

According to one first embodiment of the invention, with one wall of the said at least one incision being formed of two lines, in a circumferential plane, the intersection of the directions of the said two lines is situated at a radial distance of between 25 and 50% of the depth of the incision away from the surface of the tread.

The depth of the incision is, in a circumferential plane of section, the radial distance separating the surface of the tread from the point of the incision that is furthest from the surface of the tread. In other words, the depth is equal to the radial distance measured between the surface of the tread and the end of the line that does not lie flush with the surface of the tread and that is not in contact with the pointed tip of the V.

According to a second embodiment of the invention, with one wall of the said at least one incision being formed of two lines, in a circumferential plane, the intersection of the directions of the said two lines is situated at a radial distance of between 50 and 75% of the height of the incision away from the surface of the tread.

This second embodiment has the advantage of further optimizing the rate of wear of the tread. Specifically, the inventors have been able to demonstrate that it is that part of the incision which, in a circumferential plane of section, makes an angle with the radial direction that is oriented in the direction of rotation of the tire that has the greatest effect on the rate of wear of the tire and that the greater the depth of the tread pattern, the greater this effect becomes.

According to one alternative form of the invention, two successive lines are symmetric with respect to one another about the bisector of the angle formed by their directions. This alternative form makes it possible to optimize the properties in terms of wear notably with regard to the rate of wear; firstly, the presence of unevenness is optimized because of the inclination of each of the branches of the V and because this unevenness is lessened once the tread has worn away beyond the pointed tip of the V, and secondly, the presence of the first branch of the V in the running direction while the thickness of the tread is at its greatest makes an effective contribution towards reducing the rate of wear.

One advantageous alternative form of the invention is that the depth of the incisions varies in the axial direction notably to take account of the different rates of wear in the axial direction of the tire and to obtain tread rigidities that can vary in the axial direction.

According to one advantageous embodiment of the invention, in order to give the tire symmetric properties, the central circumferential band is advantageously centered on the equatorial plane. In other embodiments, intended for example for tires intended to run on a circuit in which all the bends are essentially in the same direction, it is possible for the central circumferential band not to be centered on the equatorial plane.

Advantageous alternative embodiments of the invention may foresee the presence of five or more circumferential bands to form at least the surface of the tread and thus provide a gradual evolution in the properties of the said tread from the equatorial plane out towards the shoulders. As before, such an embodiment may be symmetric with respect to the equatorial plane or non-symmetric, the distribution of the bands differing in terms of their composition or in terms of their distribution about the equatorial plane.

According to a preferred embodiment of the invention, the second polymer compound is of a composition different from that of the first polymer compound and, more preferably still, the second polymer compound has grip properties superior to those of the said first polymer compound.

According to other embodiments, different properties can be obtained with identical compounds by using different vulcanizing conditions.

Advantageously also, the radial thicknesses of the first and second polymer compounds may differ, so as to optimize tread wear in the axial direction. Advantageously also, the thicknesses vary gradually.

According to one preferred embodiment of the invention, the reinforcing elements of the carcass-type reinforcing structure make with the circumferential direction an angle of between 65 and 90°.

One preferred embodiment of the invention has the tire notably consisting of a crown reinforcing structure which comprises at least one layer of circumferential reinforcing elements; according to the invention, the layer of circumferential reinforcing elements consists of at least one reinforcing element oriented to make an angle less than 5° with the lower longitudinal direction.

The presence of a layer of circumferential reinforcing elements is notably preferable when producing a tire intended to be used on the rear of a motorbike.

For preference also, the reinforcing elements of the layer of circumferential reinforcing elements are metal and/or textile and/or glass. The invention notably foresees the use of reinforcing elements of different kinds within one and the same layer of circumferential reinforcing elements

For preference also, the reinforcing elements of the layer of circumferential reinforcing elements have an elastic modulus higher than 6000 N/mm².

One alternative embodiment of the invention advantageously has it that the circumferential reinforcing elements are distributed in the transverse direction at a variable pitch.

The variation in the pitch between the circumferential reinforcing elements takes the form of a variation in the number of circumferential reinforcing elements per unit length in the transverse direction and therefore of a variation in the density of circumferential reinforcing elements in the transverse direction and hence of a variation in circumferential rigidity in the transverse direction.

According to a variant of the invention, the crown reinforcing structure comprises at least one layer of reinforcing elements that make with the circumferential direction angles of between 10 and 80°.

According to this alternative form, the crown reinforcing structure advantageously comprises at least two layers of reinforcing elements, the reinforcing elements between them making angles of between 20 and 160°, from one layer to the next, preferably angles in excess of 40°.

According to one preferred embodiment of the invention, the reinforcing elements of the working layers are made of textile material.

According to another embodiment of the invention, the reinforcing elements of the working layers are made of metal.

In one advantageous embodiment of the invention, notably with a view to optimizing the rigidities of the reinforcing structure along the meridian of the tire, and in particular at the edges of the working layers, the angles made by the reinforcing elements of the working layers with the longitudinal direction can vary in the transverse direction such that the said angles are greater on the axially external edges of the layers of reinforcing elements by comparison with the angles measured at the equatorial plane of the tire.

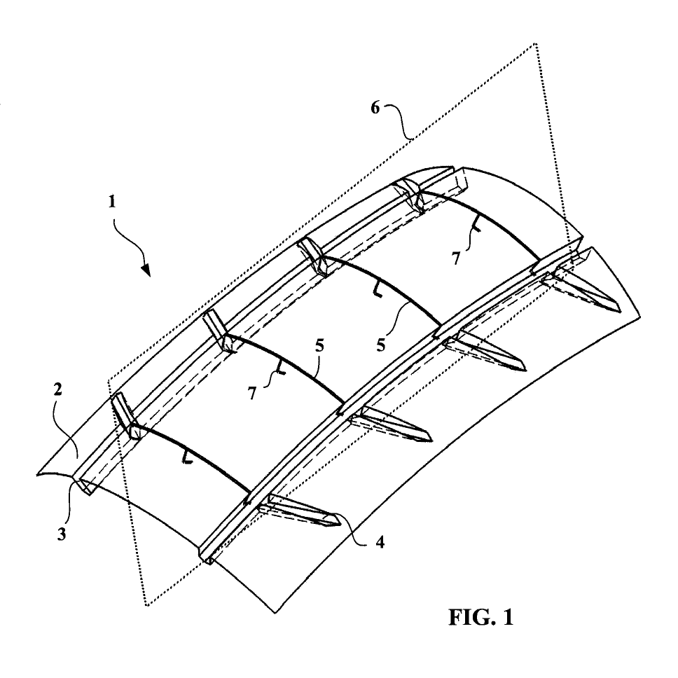

Other details and advantageous features of the invention will become apparent hereinafter from the description of exemplary embodiments of the invention with reference to FIGS. 1 to 5, which represent:

FIG. 1, a partial perspective view of a diagram of a tire according to the invention,

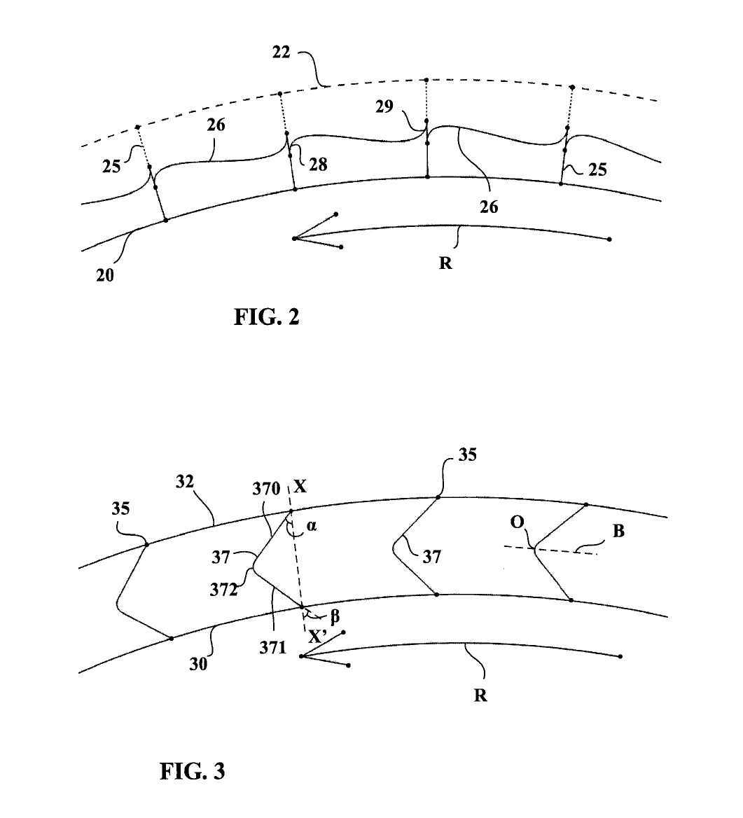

FIG. 2 a partial view in section in the equatorial plane of a diagram of the pattern of wear of a tire comprising incisions,

FIG. 3 a partial view in section in the equatorial plane of a diagram of the tire of FIG. 1,

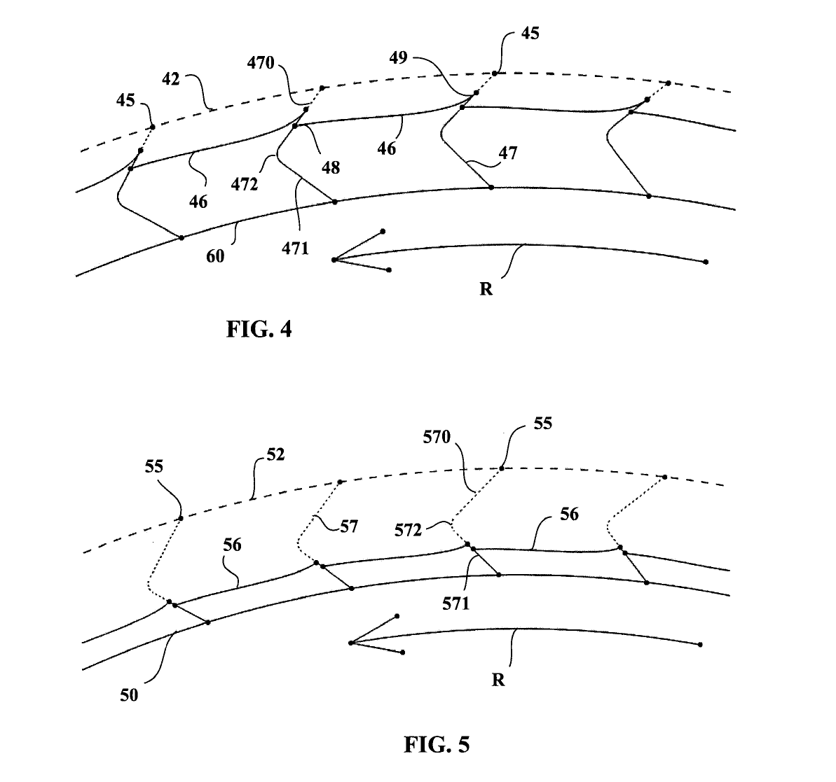

FIG. 4 a partial view in section in the equatorial plane of a diagram of the pattern of wear of the tire of FIG. 3,

FIG. 5, a partial view in section in the equatorial plane of a diagram of the pattern of wear of the tire of FIG. 3 in a more advanced level of wear.

In order to make them easier to understand, FIGS. 1 to 5 are not drawn to scale.

FIG. 1 depicts a partial perspective view of a tire 1, and more specifically of the external surface 2 of the tread thereof, intended to be fitted to the front wheel of a motorbike. The tire 1 has a curvature in excess of 0.15 and preferably in excess of 0.3. The curvature is defined by the ratio Ht/Wt, which means the ratio of the height of the tread to the maximum width of the tread of the tire.

In a way which has not been depicted in the figures, the tire 1 comprises a carcass reinforcement consisting of a layer comprising reinforcing elements of textile type. The layer consists of reinforcing elements laid radially. The radial positioning of the reinforcing elements is defined by the angle at which the said reinforcing elements are laid; a radial arrangement corresponds to the said elements being laid with respect to the longitudinal direction of the tire at an angle of between 65 and 90°.

The carcass reinforcement is anchored on each side of the tire 1 in a bead the base of which is intended to be mounted on a rim seat. Each bead is extended radially outwards by a side wall, the said side wall radially towards the outside joining to the tread.

The tire 1 further comprises a crown reinforcement consisting of a layer of circumferential reinforcing elements.

The crown reinforcement may even consist for example of two layers of reinforcing elements making angles with the circumferential direction, the said reinforcing elements being crossed from one layer to the next making between them angles for example of 50° in the region of the equatorial plane, the reinforcing elements of each of the layers making an angle of, for example, 25° with the circumferential direction. Theses layers of reinforcing elements making angles with the circumferential direction may be used instead of the layer of circumferential reinforcing elements, notably in the case of a front tire, or alternatively may be used as a combination therewith.

The tread 2 of the tire 1 comprises a tread pattern consisting of circumferentially directed continuous grooves 3 and transverse grooves 4, the main direction of the latter being at a slight angle to the radial direction in order to give the said tread pattern a direction. This orientation of the tread pattern usually, in the case of a rear tire, coincides with the direction of rotation of the tire.

The grooves 3 separate the central part of the tread from the axially external parts comprising the grooves 4 and having no incisions.

According to the invention, the central and axially external parts consist of different polymer compounds.

The polymer compound of which the central part is made has a Shore A hardness equal to 66.

The polymer compound of which the axially external parts are made has a Shore A hardness equal to 60.

The tread 2 in its central part comprises incisions or slits 5, the non-zero widths of which are very much smaller than those of the abovementioned grooves 3 and 4. These incisions according to the invention form, in the equatorial plane of section 6, a V or chevron 7 lying down, the ends of which lie flat with the surface of the tread 2. The V-shape will be described in greater detail with reference to FIG. 3.

Still according to the invention, the shape of the incisions in the equatorial plane of section can be more complicated provided it consists of two lines that make an angle of between 5 and 65° with the radial direction and that the directions of the lines between them make an angle of between 30 and 120°; it may, for example, be in the shape of the W type or alternatively of two Vs joined together.

FIG. 2 depicts a partial view in section in the equatorial plane of a diagram of a pattern of wear of a tire comprising incisions of which the orientation of the walls in a circumferential plane of section is radial.

The dotted line 22 indicates the surface of the tread when the tire is as-new. The line 20 is a line connecting the bottoms of the incisions; that may correspond to the base of the tread.

The lines 25 depict the incisions of which the orientation in the circumferential plane of section is radial. The dotted portions of these lines 25 indicate that part that has disappeared after the tread has worn away with the running of the tire.

The lines 26 indicate the profile, in a circumferential plane, between two incisions 25 on the surface of the tread following wear caused by the running of the tire. Between two incisions the tread consists of a block of rubber compound of which the surface 26 is no longer a circular profile concentric with the as-new profile 22. Considering the running direction indicated by the arrow R, the line 26 of a block of rubber compound delimited by two incisions shows a lowering of the surface on the leading edge 28 of the said block and a raising of the said surface on the trailing edge 29 of the said block. The leading edge 28 is the edge of a block that is first to come into contact with the ground during running, and the trailing edge 29 is the edge of that same block that is last to break contact with the ground during running. These successive shapes of the surface of the said blocks create a tread surface that is completely uneven, something which is prejudicial to wear and has a tendency to increase the rate of wear of the tread of the tire. Such uneven wear is also detrimental to comfort, particularly because of the noise it can cause.

FIG. 3 illustrates a partial view in cross section in the equatorial plane of a diagram of the tire of FIG. 1. The line 32 represents the surface of the tread of the tire. The line 30 is a line connecting the bottoms of the incisions 35; it may correspond to the base of the tread. These incisions 35 according to the invention have a V-shape 37. They consist of two lines 370, 371 joined together by an arc of a circle 372.

The arrow R indicates the running direction of the tire.

The line 370 which lies flush with the surface of the tread 32 makes an angle α with the radial direction, embodied by the axis XX′. The angle α is oriented in the running direction R of the tire.

The line 371 makes an angle β with the radial direction oriented in the opposite direction to the running direction R of the tire.

As explained earlier, an angle of inclination of an incision with respect to the radial direction that is in the running direction R of the tire is better for rate of wear as long as the thickness of the tread pattern is great. The line 370 is therefore advantageously inclined in the running direction R in order to play a part in reducing the rate of wear.

In FIG. 3, it may also be seen that lines 370 and 371 are symmetric about the straight line B that represents the bisector of the angle formed by the intersection O of the lines 370 and 371. The angles α and β are therefore identical in terms of absolute value. Configuring the incisions 35 in this way makes it possible to reach a compromise between rate of wear and the evenness of the pattern of wear. Specifically, as FIGS. 4 and 5 will show, the pattern of wear of the tread is less detrimental than in the case of radial incisions in a circumferential plane and orienting the first line 370 in the running direction R of the tire makes it possible to reduce the rate of tread wear.

FIG. 4 depicts a partial view in section in the equatorial plane of a diagram of the pattern of wear of the tire of FIG. 3 when it has become slightly worn.

The portions of the incisions 45 depicted in dotted line indicate those portions of the tire that have disappeared as a result of wear.

The lines 46 indicate the profile, in a circumferential plane, between two incisions 45 on the surface of the tread following wear caused by the running of the tire. Between two incisions the tread consists of a block of rubber compound of which the surface 46 is no longer a circular profile concentric with the as-new profile 42. Considering the running direction indicated by the arrow R, the line 46 of a block of rubber compounds delimited by two incisions shows that at the leading edge 48 of the said block, the surface remains even whereas at the trailing edge 49 the surface is raised. These successive shapes of the surface of the said blocks create an uneven tread surface the unevennesses of which are, however, less pronounced than they were in FIG. 2, and which have less of an effect on the rate of wear.

FIG. 5 depicts a partial view in section in the equatorial plane of a diagram of the pattern of wear of the tire of FIG. 3 after it has worn to a greater extent that in FIG. 4. The tread wear has notably begun to wear away the lines 571 that constitute part of the incisions 55, the lines 570 having completely disappeared.

Those portions of the incisions 55 that are depicted in dotted line represent those portions of the tire that have disappeared as a result of wear.

The lines 56 represent the profile in a circumferential plane between two incisions 55 of the tread surface following wear through running of the tire. Between two incisions the tread consists of a block of rubber compound of which the surface 56 is no longer a circular profile concentric with the as-new profile 52 as in the case of the previous figure.

By contrast, this FIG. 5 shows that the progressive wear corresponding to the disappearance of the lines 571 reduces the unevennesses that appear through wear corresponding to the disappearance of the lines 570. Indeed it has been found that orientating in the opposite direction to the running direction R the lines 571 that appear after a pattern of wear that is obtained after the lines 570 have disappeared leads to a more even pattern of tire wear.

The invention must not be considered to be limited to the description of the examples above. In particular, it foresees combining the embodiments of the invention that have been illustrated in the figures with architectures that can vary in the axial direction, with layers of reinforcing elements oriented circumferentially the pitch of which varies in the axial direction and angles of the reinforcing elements of the working layers that can vary in the axial direction.

Moreover, the invention even foresees combining incisions such as those described hereinabove with other types of incision such as incisions that are not inclined and are therefore oriented radially in a circumferential plane of section or even with incisions that have an inclination such that in a circumferential plane of section the incision makes an angle with the radial direction.

Tests have been conducted on a tire of 180/55 ZR 17 size produced according to FIGS. 1 and 3.

This tire was compared against two reference tires identical to the tire of the invention except for a complete absence of incisions on the tread of the tire R1 and the presence of incisions that were not inclined and were therefore oriented radially on the tire R2. The number of incisions on the tire according to the invention and on the reference tire R2 were the same.

The tests involved running three motorbikes in convoy around a circuit and switching the tires between the motorbikes, the riders remaining the same so that each tire had covered the same distance on each motorbike. The results correspond to a percentage of wear of the tread at the equatorial plane after running for 5000 kilometers.

The results of tire R2 were adopted as reference and assigned the value 100.

The reference tire R1 that had no incisions achieved the value 85.

The initial results show that the presence of incisions oriented radially in a circumferential plane of section does actually increase the rate of wear.

The tire according to the invention achieved a value of 87.

These results show that the incisions proposed according to the invention make it possible to produce tires of which the properties in terms of wear are almost the same as those of a tire with no incisions.

Other tests were conducted on the same tires to compare grip on wet ground. The results are a subjective assessment averaged across the observations made by the three riders.

The value of 100 was assigned to the reference tire R1.

The tire according to the invention and the reference tire R2 were assigned the same score of 120.

These results clearly show that the presence of the incisions on the tires appreciably improves performance in terms of grip on wet ground.

1.-12. (canceled)

13. A for a motorized two-wheeled vehicle comprising a reinforcing structure of the carcass type, made up of reinforcing elements, anchored on each side of the tire to a bead the base of which is adapted to be mounted on a rim seat, each bead being extended radially outwards by a sidewall, the sidewalls radially toward the outside joining to a tread, wherein at least the surface of the tread includes a first polymer compound extending over at least part of the central part and of at least one second polymer compound having physico-chemical properties different from those of said first polymer compound and covering at least part of the axially external parts of the tread, wherein at least the central part of the tread comprises at least one incision, wherein, in the central part of the tread consisting of said first polymer compound, in a circumferential plane, at least part of one wall of said at least one incision is formed of at least two lines, wherein each of the lines makes with the radial direction an angle of between 5 and 65°, and wherein the directions of two successive lines make an angle of between 30 and 120° between them.

14. The tire according to claim 13, wherein said at least two lines are connected by an arc of a circle.

15. The tire according to claim 13, one wall of said at least one incision being formed of two lines, wherein said two lines are symmetric with respect to one another about the bisector of the angle formed by their directions.

16. The tire according to claim 13, one wall of said at least one incision being formed of two lines, wherein the intersection of the directions of the said two lines is oriented in the running direction of the tire with respect to the ends of the two lines.

17. The tire according to claim 13, one wall of said at least one incision being formed of two lines, wherein in a circumferential plane, the intersection of the directions of said two lines is situated at a radial distance of between 25 and 50% of the depth of the incision away from the surface of the tread.

18. The tire according to claim 13, one wall of said at least one incision being formed of two lines, wherein in a circumferential plane, the intersection of the directions of said two lines is situated at a radial distance of between 50 and 75% of the height of the incision away from the surface of the tread.

19. The tire according to claim 13, wherein the reinforcing elements of the carcass-type reinforcing structure make with the circumferential direction an angle of between 65 and 90°.

20. The tire according to claim 13, wherein the crown reinforcing structure comprises at least one layer of circumferential reinforcing elements.

21. The tire according to claim 20, wherein the circumferential reinforcing elements are distributed in the transverse direction at a variable pitch.

22. The tire according to claim 13, wherein the crown reinforcing structure comprises at least one layer of reinforcing elements, known as the working layer, and wherein the reinforcing elements make with the circumferential direction angles of between 10 and 80°.

23. The tire according to claim 22, wherein the angles made by the reinforcing elements of the said at least one working layer with the longitudinal direction can vary in the transverse direction
